(19) United States
(12) Patent Application Publication
(10) Pub. No.: US 2017/0173640 A1
(43) Pub. Date: Jun. 22, 2017

(54) LOW TEMPERATURE SOLAR COLLECTOR CLEANER

(71) Applicants: Marc Grossman, Davis, CA (US); Cedric Jeanty, Davis, CA (US); Matt Campbell, Berkeley, CA (US)

(72) Inventors: Marc Grossman, Davis, CA (US); Cedric Jeanty, Davis, CA (US); Matt Campbell, Berkeley, CA (US)

(21) Appl. No.: 14/975,517

(22) Filed: Dec. 18, 2015

(51) Int. Cl. B08B 3/00; H02S 40/10; B08B 1/00

(52) U.S. Cl. CPC B08B 3/00; B08B 1/001; H02S 40/10; B08B 2240/00

(57) ABSTRACT

A photovoltaic (PV) robotic cleaning device can include a cleaning head configured to apply a vaporized cleaning solution on a portion of a PV collector while the PV robotic cleaning device is traveling over the PV collector, where the vaporized cleaning solution can heat the portion of a PV collector while travelling. The photovoltaic (PV) robotic cleaning device can include a squeegee element coupled to the cleaning head, where the squeegee element can be configured to remove a cleaning solution formed by the vaporized cleaning solution.

### BACKGROUND

Photovoltaic (PV) cells, commonly known as solar cells, are devices for conversion of solar radiation into electrical energy. Generally, solar radiation impinging on the surface of, and entering into, the substrate of a solar cell creates electron and hole pairs in the bulk of the substrate. The electron and hole pairs migrate to p-doped and n-doped regions in the substrate, thereby creating a voltage differential between the doped regions. The doped regions are connected to the conductive regions on the solar cell to direct an electrical current from the cell to an external circuit. When PV cells are combined in an array such as a PV collector, the electrical energy collected from all of the PV cells can be combined in series and parallel arrangements to provide power with a certain voltage and current.

In the field, PV collectors can collect dust, dirt, or other particulates, which can block some amount of solar radiation and ultimately reduce the amount of energy produced by the PV collector.

### BRIEF DESCRIPTION OF THE DRAWINGS

FIG. 1 illustrates a profile view of an example photovoltaic robotic cleaning device, according to some embodiments.

FIG. 2 illustrates a profile view of an example cleaning head, according to some embodiments.

FIG. 3 illustrates a profile view of a dispensing element, according to some embodiments.

FIG. 4 illustrates a cross-sectional view of another example cleaning head, according to some embodiments.

FIG. 5 is a flowchart of an example method for operating a robotic cleaning device, according to some embodiments.

FIG. 6 is a cross-sectional view illustrating cleaning a photovoltaic collector, according to some embodiments.

### DETAILED DESCRIPTION

The following detailed description is merely illustrative in nature and is not intended to limit the embodiments of the subject matter of the application or uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, brief summary or the following detailed description.

This specification includes references to “one embodiment” or “an embodiment.” The appearances of the phrases “in one embodiment” or “in an embodiment” do not necessarily refer to the same embodiment. Particular features, structures, or characteristics may be combined in any suitable manner consistent with this disclosure.

Terminology. The following paragraphs provide definitions and/or context for terms found in this disclosure (including the appended claims):

“Comprising.” This term is open-ended. As used in the appended claims, this term does not foreclose additional structure or steps.

“Configured To.” Various units or components may be described or claimed as “configured to” perform a task or tasks. In such contexts, “configured to” is used to connote structure by indicating that the units/components include structure that performs those task or tasks during operation. As such, the unit/component can be said to be configured to perform the task even when the specified unit/component is not currently operational (e.g., is not on/active). Reciting that a unit/circuit/component is “configured to” perform one or more tasks is expressly intended not to invoke 35 U.S.C. §112, sixth paragraph, for that unit/component.

“First,” “Second,” etc. As used herein, these terms are used as labels for nouns that they precede, and do not imply any type of ordering (e.g., spatial, temporal, logical, etc.). For example, reference to a “first” squeegee element does not necessarily imply that this squeegee element is the first squeegee element in a sequence; instead the term “first” is used to differentiate this squeegee element from another squeegee element (e.g., a “second” squeegee element).

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While B may be a factor that affects the determination of A, such a phrase does not foreclose the determination of A from also being based on C. In other instances, A may be determined based solely on B.

“Coupled”—The following description refers to elements or nodes or features being “coupled” together. As used herein, unless expressly stated otherwise, “coupled” means that one element/node/feature is directly or indirectly joined to (or directly or indirectly communicates with) another element/node/feature, and not necessarily mechanically.

“Inhibit”—As used herein, inhibit is used to describe a reducing or minimizing effect. When a component or feature is described as inhibiting an action, motion, or condition it may completely prevent the result or outcome or future state completely. Additionally, “inhibit” can also refer to a reduction or lessening of the outcome, performance, and/or effect which might otherwise occur. Accordingly, when a component, element, or feature is referred to as inhibiting a result or state, it need not completely prevent or eliminate the result or state.

In addition, certain terminology may also be used in the following description for the purpose of reference only, and thus are not intended to be limiting. For example, terms such as “upper”, “lower”, “above”, and “below” refer to directions in the drawings to which reference is made. Terms such as “front”, “back”, “rear”, “side”, “outboard”, and “inboard” describe the orientation and/or location of portions of the component within a consistent but arbitrary frame of reference which is made clear by reference to the text and the associated drawings describing the component under discussion. Such terminology may include the words specifically mentioned above, derivatives thereof, and words of similar import.

In the following description, numerous specific details are set forth, such as specific operations, in order to provide a thorough understanding of embodiments of the present disclosure. It will be apparent to one skilled in the art that embodiments of the present disclosure may be practiced without these specific details. In other instances, well-known techniques are not described in detail in order to not unnecessarily obscure embodiments of the present disclosure.

As described herein, light receiving surfaces of solar collection devices can accumulate dirt, dust, or other particulates (e.g., airborne particulates) that can block light that would otherwise be incident on the collector surface. Such accumulation can reduce the potential power output of the solar collector(s). It can become increasingly challenging to clean PV collectors located in lower temperature environments (e.g., ambient temperatures below 0 degrees Celsius), where, for example, the cleaning solution (e.g., water) used to clean a surface of the PV collector can freeze on the surface and require the removal of the frozen solution before cleaning, which can be difficult to do. The disclosed structures and techniques can offer improved cleaning and reduced cost and energy to perform the cleaning.

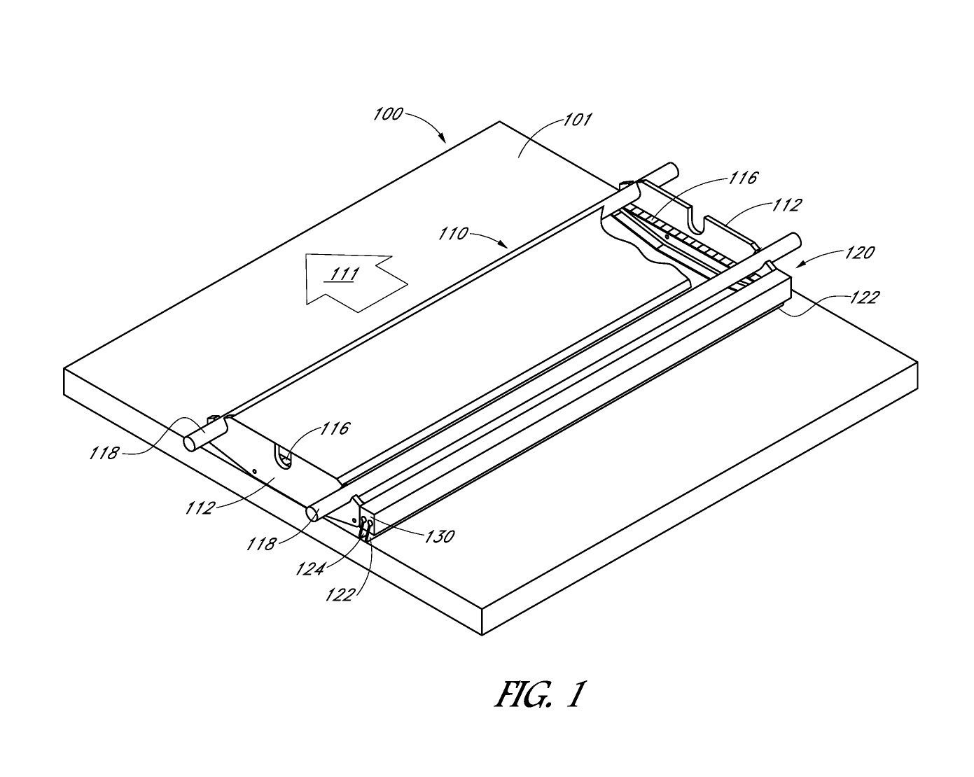

FIG. 1 depicts an example photovoltaic (PV) robotic cleaning device for cleaning photovoltaic collectors. The PV robotic cleaning device 110 depicted in FIG. 1 is configured to clean a PV collector 100 by traversing across the PV collector surface 101. As used herein, the term PV collector is used interchangeably with the term PV module. Although illustrated as covering a single PV collector at a time, in some embodiments, the PV robotic cleaning device 110 can accommodate multiple PV collectors (e.g., in succession). In an example, the PV robotic cleaning device 110 can be configured to clean a row of PV collectors by traversing across the collector surface of an array of PV collectors and by crossing gaps between adjacent PV collectors.

The PV robotic cleaning device 110 can include end plates 112. The end plates 112 can be structurally joined by two lateral beams 118. The end plates 112 can be attached to the lateral beams 118 by a clamping mechanical interface that allows the plates to be unclamped and moved along the length of the lateral beams 118. The PV robotic cleaning device 100 can include continuous track mechanisms 116. The distance between the respective continuous track mechanisms 116 can be varied by moving the length of the lateral beams 118 to change the distance between track mechanisms 116. In this way, the robotic cleaning device 110 may be configured to fit a variety of differently sized PV collectors.

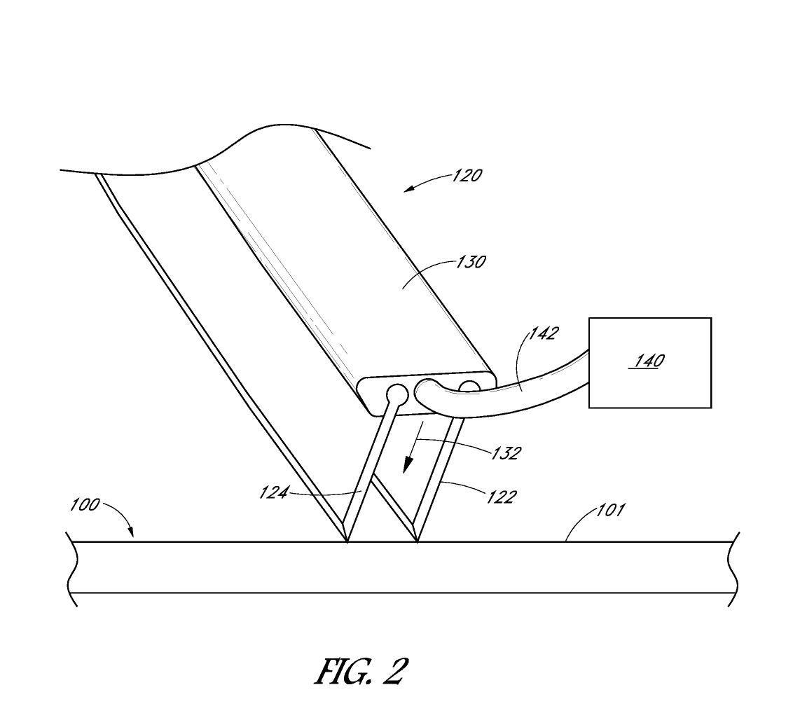

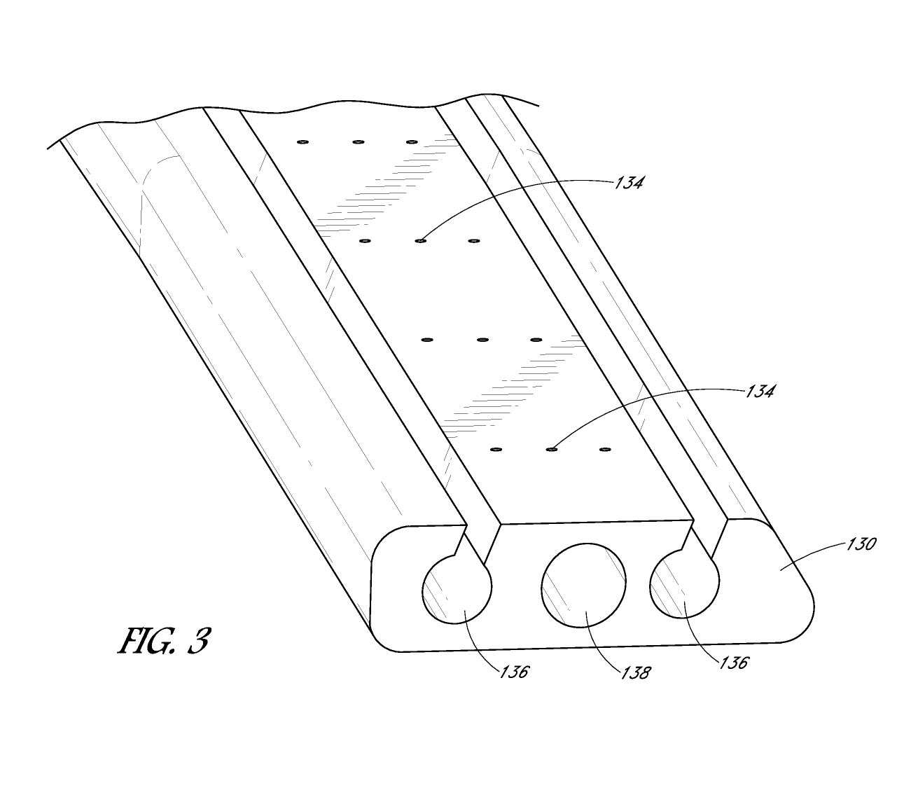

The PV robotic cleaning device 110 can include one, or more, cleaning heads 120 for cleaning the collector surface of a solar collector 100. The cleaning head 110 can include one or more components for removing accumulated particulates from the surface 101 of a PV collector 100. The cleaning head 120 can include a dispensing element 130, where first and second squeegee elements 122, 124 can be coupled to the dispensing element 130 as shown. In an example, the dispensing element 130 can be a vapor (e.g., steam) dispensing element. The example cleaning head 120, featuring a dual-squeegee configuration, is discussed in more detail below with respect to FIGS. 2 and 3. However, in other embodiments, PV robotic cleaning device 110 may not include a dual-squeegee configuration, such as a zero, one, or more than two squeegee configuration. The direction 111 of cleaning over a PV collector 100 is shown.

FIG. 2, illustrates a cleaning head of a PV robotic cleaning device, according to some embodiments. In an embodiment, the cleaning head 120 can be configured to dispense a vaporized cleaning solution 132. In one embodiment, the cleaning head 120 can include a dispensing element 130. In an embodiment, the dispensing element 130 can be configured to dispense the vaporized cleaning solution 132. In an example, the dispensing element 130 can include a plurality of holes through which a vaporized cleaning solution can be dispensed. In an example, the vaporized cleaning solution 132 can include steam or saturated steam. In an embodiment, first and second squeegee elements 122, 124 can be coupled to the dispensing element 130 as shown. In an embodiment, the first and second squeegee elements 122, 124 can inhibit the vaporized cleaning solution 132 from escaping from between the dispensing element 130, and a surface 101 of the PV collector 100 during the dispensing, shown in of FIG. 1.

In an embodiment, the cleaning head 120 can be connected to a cleaning solution reservoir 140 through a vaporized cleaning solution supply line 142. In one embodiment, the cleaning solution reservoir 140 can include the vaporized cleaning solution. In an embodiment, the cleaning solution reservoir 140 can be located externally and/or separately from the PV robotic cleaning device 110. In an example, the cleaning solution reservoir 140 can be located on a support vehicle separate from the PV robotic cleaning device 110. In some embodiments, the cleaning solution reservoir 140 can be located within the PV robotic device. In an embodiment, the vaporized cleaning solution supply line 142 can be configured to provide the vaporized cleaning solution from the cleaning solution reservoir 140 to the dispensing element 130. In an example, the vaporized cleaning supply line 142 can connect the cleaning solution reservoir 140 to the dispensing element 130. In one example, the vaporized cleaning supply line 142 can act as a channel to supply vaporized cleaning solution to the dispensing element 130. In some embodiments, the cleaning solution reservoir 140 can include a heater, where the heater can be configured to heat a cleaning solution to form the vaporized cleaning solution. In an example, the cleaning solution reservoir 140 can be heated using propane or diesel (e.g., by burning propane or diesel) to form a vaporized cleaning solution. In some embodiments, the heater may or may not be included with the cleaning solution reservoir 140.

Using a vaporized cleaning solution can offer many advantages over alternative cleaning solutions, such as improved cleaning and reduced amount of cleaning solution and power needed. The difficulty with cleaning with a liquid cleaning solution (e.g., cold, warm, or hot water) in low temperature environments (e.g., below 0 degrees Celsius) is that a sufficient amount of liquid cleaning solution and heat is required to heat the a bulk area (e.g., entire volume) of an object to be cleaned to prevent a surface layer of water from freezing. Cleaning with vapor (e.g., steam) allows to rapidly heat the surface being cleaned to above freezing temperature then remove the condensate before it has had time to be cooled to below freezing (e.g., transition from liquid to solid) from the portion of the object's volume that is still below freezing. For example, a system using heated water to clean a PV module surface, e.g., glass, instead of a vaporized cleaning solution (e.g., steam) may not work well because the heated water will nevertheless freeze because the thermal conductivity of water is lower than glass or it would require a substantial amount of water and power to heat the water to overcome the lower thermal conductivity of water. Similarly, a system using additives, such as methanol, in the cleaning solution can be costly and also require a more complicated system that can recirculate and re-use the cleaning solution.

With reference to FIG. 3, a dispensing element is shown, according to some embodiments. In an example, the dispensing element 130 can include slots 136 for inserting the squeegees 122, 124 from FIGS. 1 and 2. The squeegees 122, 124 of FIGS. 1 and 2 can be replaced by sliding a bulb-shaped or other-shaped top end of the squeegees out of slots 136, respectively. In an embodiment, the dispensing element 130 can include an opening 138, where the opening 138 can be configured to receive the vaporized cleaning solution supply line 142 of FIG. 2. In an example, the vaporized cleaning solution supply line 142 can have a supply line configured to connect to the opening 138. In some examples, the dispensing element 130 can be configured to dispense steam. In one example, the dispensing element 130 can be a steam dispensing element. In an example, the dispensing element 130 can include a plurality of holes 134 through which a vaporized cleaning solution can be dispensed.

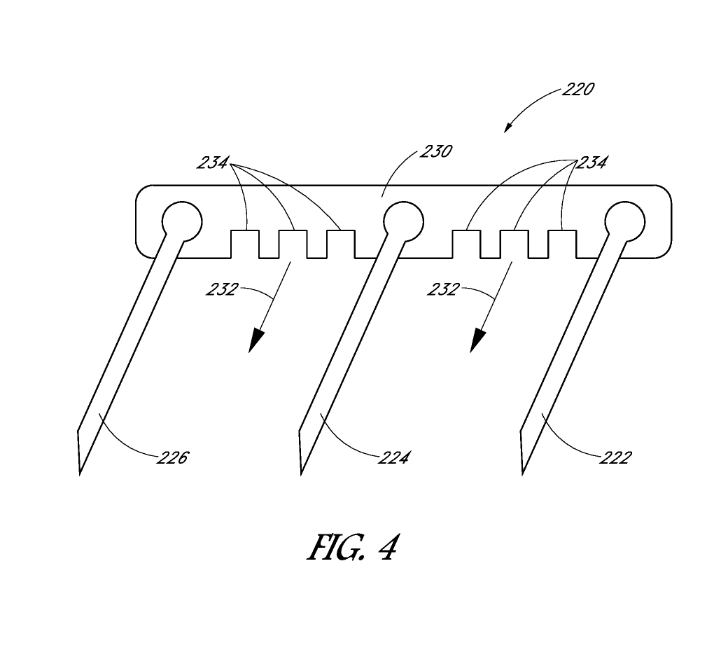

FIG. 4 illustrates a cross-sectional view of another cleaning head of a PV robotic cleaning device, according to some embodiments. In an embodiment, the cleaning head 220 is substantially similar to the cleaning head 120 of FIG. 2. As shown, the cleaning head 220 has similar reference numbers to elements of the cleaning head 120 of FIG. 2, where like reference numbers refer to similar elements throughout the figures. In an embodiment, the structure of the cleaning head 220 is substantially similar to the structure of the cleaning head 120 in FIG. 2, except as described below. Therefore the description of corresponding portions of FIG. 2 applies equally to the description of FIG. 4.

In an embodiment, the cleaning head 220 can include a dispensing element 230. In one embodiment, the cleaning head 220 can have a plurality of squeegee elements 222, 224 and 226. In one example, a first, second and third squeegee elements 222, 224, 226 can be coupled to the dispensing element 230, as shown. In an embodiment, the cleaning head 220 can dispense a vaporized cleaning solution 232. In an embodiment, the first, second and third squeegee elements 222, 224, 226 can inhibit the vaporized cleaning solution 232 from escaping from between the dispensing element 230, and a surface of a PV collector. In an embodiment, the first, second and/or third squeegee elements 222, 224, 226 can be configured to remove a cleaning solution formed (e.g., from the condensate of the vaporized cleaning solution 232) on a surface of the PV collector. In some embodiments, only the second and third squeegee elements 224, 226 can be configured to remove a cleaning solution formed on a surface of the PV collector by the vaporized cleaning solution 232. In an example, a PV robotic cleaning device can drag the first, second and/or third squeegee elements 222, 224, 226 on the PV collector surface to collect the condensate of the vaporized cleaning solution 232 and drag the condensate off an edge of the PV collector.

In an embodiment, the cleaning head 220 can include a brush. In one embodiment, the brush can be configured to remove dirt, dust, and/or other particulates (e.g., airborne particulates) collected on the surface of a PV collector prior to removing the cleaning solution. In an example, the brush can be applied before the condensate has time to freeze. In an embodiment, the first, second and/or third squeegee elements 222, 224, 226 can be configured to remove a cleaning solution formed on a surface of the PV collector after applying the brush on the surface of the PV collector. In an embodiment, the vaporized cleaning solution 232 can be applied to the brush to heat the brush and/or prevent condensate from freezing on the brush.

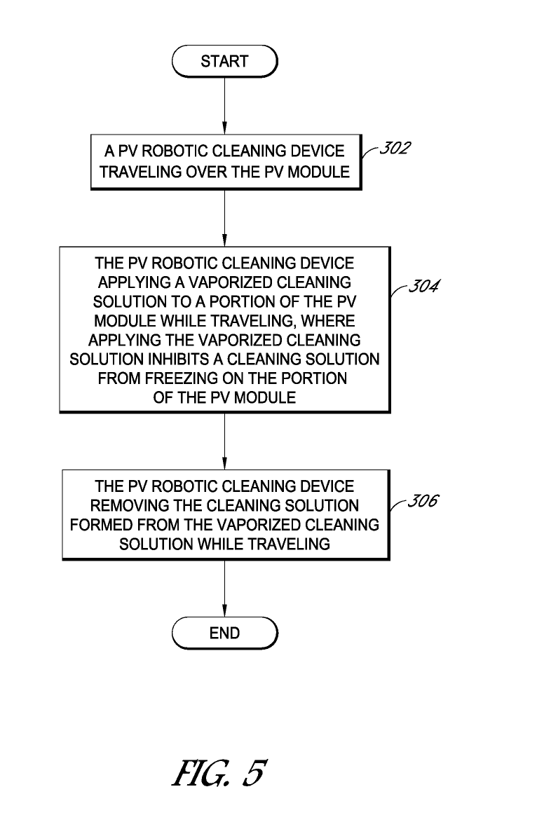

Turning now to FIG. 5, a method for operating a photovoltaic (PV) robotic cleaning device is shown, according to some embodiments. In various embodiments, the method of FIG. 1 can include additional (or fewer) blocks than illustrated. For example, in some embodiments after cleaning a first PV collector, the photovoltaic robotic cleaning device may travel over a second PV collector to clean the second PV collector.

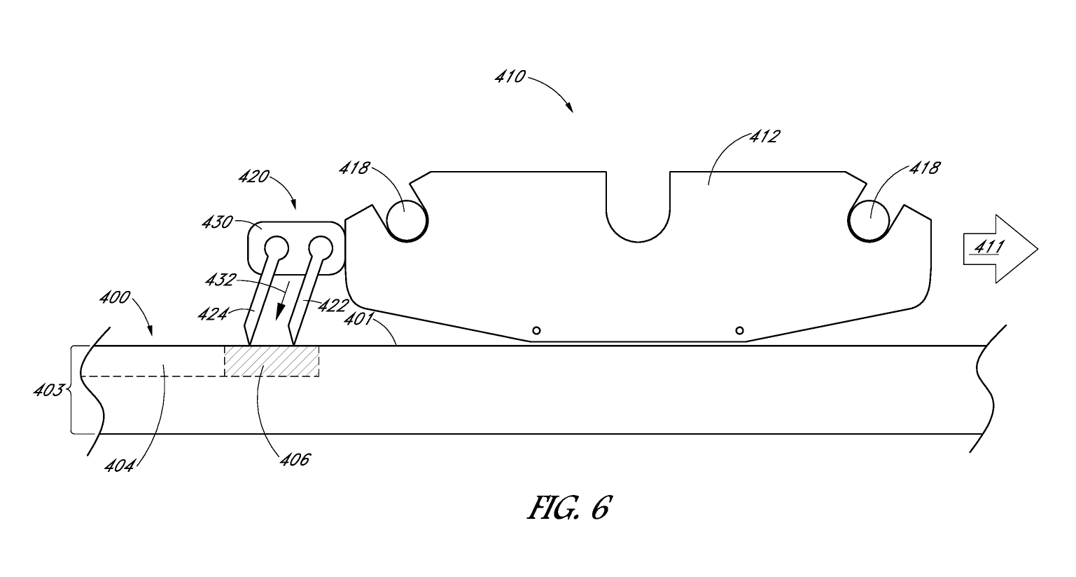

FIG. 6 illustrates a cross-sectional view of photovoltaic (PV) robotic cleaning device cleaning a photovoltaic collector, according to some embodiments. In an embodiment, the PV collector 400 can include a substantially transparent top portion 403. In an example, the substantially transparent top portion 403 can be glass. In one example, the substantially transparent top portion 403 can have a thickness in the range of 2-3 millimeters. As shown, the PV robotic cleaning device 410 can be placed over the substantially transparent top portion 403 of the PV collector 400. In an embodiment, the PV collector 400 can include other components including solar cells, a backsheet, frame, among other components, these components are not shown to simplify the presentation and not distract from the present discussion only.

In an embodiment, the PV robotic cleaning device 410 is substantially similar to the PV robotic cleaning device 110 of FIG. 1. As shown, the PV robotic cleaning device 410 has similar reference numbers to elements of the PV robotic cleaning device 110 of FIG. 1, where like reference numbers refer to similar elements throughout the figures. In an embodiment, the structure of the PV robotic cleaning device 410 is substantially similar to the structure of the PV robotic cleaning device 110 in FIG. 1, except as described below. Therefore the description of corresponding portions of FIG. 1 applies equally to the description of FIG. 6.

Referring to FIG. 6, and corresponding operation 302 of the flowchart of FIG. 5, a PV robotic cleaning device 410 can travel over a PV module 400, according to some embodiments. In an embodiment, the PV robotic cleaning device 410 can travel at a speed that allows a cleaning solution to form from a vaporized cleaning solution 432 (e.g., from the condensate of the vaporized cleaning solution 432). In one embodiment, the PV robotic cleaning device 410 can travel 411 at a speed in a range of approximately 0.1-1 m/s.

Referring to FIG. 6, and corresponding operation 304 of the flowchart of FIG. 5, a PV robotic cleaning device 110 can apply a vaporized cleaning solution to a portion of the PV collector while traveling over a PV collector, according to some embodiments. In an embodiment, applying a vaporized cleaning solution 432 to a portion 406 of the PV collector 400 while traveling 411 can include applying steam or saturated steam to the first portion 406 of the PV collector 400.

In an embodiment, applying a vaporized cleaning solution 432 can heat a portion 406 of the PV collector 400, where the heat can allow a cleaning solution to condense from the vaporized cleaning solution 432 on the portion 406 of the PV collector. In an example, use of the vaporized cleaning solution 132 can inhibit the cleaning solution (e.g., condensate from the vaporized cleaning solution 432) from freezing on the portion 406 of the PV module 400. In one example, the vaporized cleaning solution 432 can be applied at a temperature approximately greater than 100 degrees Celsius. In one example, as shown, before applying the vaporized cleaning solution 432, the portion 406 can be at a first temperature. In an example, the first temperature can be in a range of approximately −15 to 0 degrees Celsius. In an example, applying the vaporized cleaning solution 432 can heat the portion 406 to a second temperature, where the second temperature can be greater than approximately 0 degrees Celsius. After the cleaning, other portions, 402, 404 of the PV collector can return to an ambient temperature. In an example, the portions 402, 404 already cleaned by the PV robotic cleaning device can return to a temperature below 0 degrees Celsius. In one example, the ambient temperature while applying can be in a range of −15 to 0 degrees Celsius. In an embodiment, the vaporized cleaning solution 432 can be steam. In an example, the cleaning solution (e.g., condensate of the vaporized cleaning solution 432) can be water. As shown, applying a vaporized cleaning solution 432 allows for only a portion of the PV collector (e.g., 406) to be heated without having to heat the entire PV collector. In an example, heating only a portion of the PV collector can save energy, reduce costs, and clean the PV collector better in comparison to other methods, such as using heated water.

In an embodiment, the cleaning head can include first and second squeegee elements 422, 424. In an example, the first and second squeegee elements 422, 424 can inhibit the vaporized cleaning solution 432 from escaping from between the dispensing element 430, and the surface 401 during the application. However, in other embodiments, PV robotic cleaning device 110 can include a one, or more than two squeegee configuration.

Referring to FIG. 6, and corresponding operation 306 of the flowchart of FIG. 5, a PV robotic cleaning device 110 can remove the cleaning solution formed from the vaporized cleaning solution while traveling, according to some embodiments. In an example, dirt, dust, sand, among other contaminants can be removed from the PV module while traveling.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

1. A photovoltaic (PV) robotic cleaning device, comprising:
a cleaning head configured to apply a vaporized cleaning solution on a portion of a PV collector while the PV robotic cleaning device is traveling over the PV collector; and
a squeegee element coupled to the cleaning head, wherein the squeegee element is configured to remove a cleaning solution formed by the condensation of the vaporized cleaning solution.

2. The PV robotic cleaning device of claim 1, wherein the cleaning head is configured to apply steam on the portion of the PV collector.

3. The PV robotic cleaning device of claim 1, wherein the squeegee element is configured to remove condensate formed by the condensation of the vaporized cleaning solution.

4. The PV robotic cleaning device of claim 1, wherein the cleaning head is configured to apply a vaporized cleaning solution at a temperature approximately greater than 100 degrees Celsius to the portion of the PV collector.

5. The PV robotic cleaning device of claim 1, wherein the cleaning head comprises a dispensing element configured to apply a vaporized cleaning solution on a portion of a PV collector.

6. The PV robotic cleaning device of claim 5, wherein the dispensing element comprises a plurality of holes configured to apply vaporized cleaning solution on a portion of a PV collector.

7. The PV robotic cleaning device of claim 5, further comprising a vaporized cleaning solution supply line configured to provide vaporized cleaning solution to the dispensing element.

8. The PV robotic cleaning device of claim 5, further comprising:
a cleaning solution reservoir;
a heater configured to heat the cleaning solution in the cleaning solution reservoir to form a vaporized cleaning solution; and
a vaporized cleaning solution supply line configured to provide the vaporized cleaning solution to the dispensing element.

9. A photovoltaic (PV) robotic cleaning device, comprising:
a cleaning head including a dispensing element configured to apply a vaporized cleaning solution on a portion of a PV collector while the PV robotic cleaning device is traveling over the PV collector; and
first and second squeegee elements coupled to the dispensing element, wherein the second squeegee element is configured to remove a cleaning solution formed by the vaporized cleaning solution.

10. The PV robotic cleaning device of claim 9, further comprising:
a third squeegee element coupled to the dispensing element, wherein the second and third squeegee elements are configured to remove a cleaning solution formed by the vaporized cleaning solution.

11. The PV robotic cleaning device of claim 9, wherein the dispensing element is configured to apply steam on the portion of the PV collector.

12. The method of claim 9, wherein the dispensing element is configured to apply the vaporized cleaning solution at a temperature approximately greater than 100 degrees Celsius to the portion of the PV collector.

13. The PV robotic cleaning device of claim 9, further comprising a vaporized cleaning solution supply line configured to provide vaporized cleaning solution to the dispensing element.

14. The PV robotic cleaning device of claim 9 further comprising:
a cleaning solution reservoir;
a heater configured to heat the cleaning solution in the cleaning solution reservoir to form a vaporized cleaning solution; and
a vaporized cleaning solution supply line configured to provide the vaporized cleaning solution to the dispensing element.

15. A method for cleaning a photovoltaic (PV) collector, the method comprising;
a PV robotic cleaning device traveling over the PV collector;
the PV robotic cleaning device applying a vaporized cleaning solution to a portion of the PV collector while traveling, wherein applying the vaporized cleaning solution inhibits a cleaning solution from freezing on the portion of the PV collector; and
the PV robotic cleaning device removing the cleaning solution formed from the vaporized cleaning solution while traveling.

16. The method of claim 15, wherein said traveling over the PV collector comprises traveling at a speed that allows cleaning solution to form from the vaporized cleaning solution before said removing.

17. The method of claim 15, wherein the speed is in a range of approximately 0.1-1 m/s.

18. The method of claim 15, wherein applying the vaporized cleaning solution to the portion comprises applying steam to the portion of the PV collector.

19. The method of claim 15, wherein applying the vaporized cleaning solution comprises applying the vaporized cleaning solution at a temperature approximately greater than 100 degrees Celsius.

20. The method of claim 15, wherein removing the cleaning solution from the portion while traveling comprises removing the cleaning solution including contaminants from the portion of the PV collector while traveling.

21.-24. (canceled)
